(19) United States
(12) Patent Application Publication
(10) Pub. No.: US 2022/0114664 A1
(43) Pub. Date: Apr. 14, 2022

(54) USE OF MACHINE LEARNING TO FORECAST, RECOMMEND, AND TRADE SECURITIES IN CURRENCY MARKETS

(71) Applicant: Sadface Overlord Corporation, Hartland, WI (US)

(72) Inventor: Daniel Ryan Curtis, Hartland, WI (US)

(73) Assignee: Sadface Overlord Corporation, Hartland, WI (US)

(21) Appl. No.: 17/066,267

(22) Filed: Oct. 8, 2020

(51) Int. Cl. G06Q 40/04; G06N 20/00; G06N 5/04; G06Q 20/38; G06Q 20/06; G06Q 40/02; G06Q 10/10

(52) U.S. Cl. CPC G06Q 40/04; G06N 20/00; G06N 5/04; G06Q 2220/00; G06Q 20/0655; G06Q 40/02; G06Q 10/10; G06Q 20/381

(57) ABSTRACT

Machine learning-based approaches are used to predict market data, determine financial recommendations, and execute those recommendations. For example, for a plurality of time periods, a prediction model can be trained. The prediction models can be trained on market data and market activity that correspond to each prediction models' period of time. The prediction models can process market data and market activity to determine a predicted currency score and time-limited exchange rate for the time period a prediction model is associated with. For a selected time period, a trained model can evaluate market data to predict a currency value that satisfies a threshold level of change. The value (e.g., a next value currency) can then be used to, for example, complete a financial transaction, a document agreement, and the like.

### BACKGROUND

There are numerous currencies in the world, and understanding the trading price of any of these currencies during a given time interval is increasingly becoming more difficult in today's fast-paced economy, let alone possible to forecast effectively. As such, companies are faced with limited options to maintain their international operations, and frequently opt to enter into forward contracts to minimize financial risk. Moreover, traders and companies seeking to enter into foreign markets must contend with many factors that affect currency prices, including, for example, inflation. The rise in cryptocurrency usage has provided a new means to transact currency on the open market. However, while many companies and investors are looking to leverage cryptocurrency trading as part of a more comprehensive securities strategy, the market is young and exceptionally volatile. As a result, international contracts may be hindered due to fluctuations in the values of international currencies with respect to one another. This issue may be compounded when there is a delay between the time of agreement and the time of performance. That is, a seller may agree to a price today but may receive a substantially lower actual price at a later date when the transaction or contract is performed. This may occur, for example, when the seller's native currency decreases in value vis-à-vis the buyer's native currency during the delay period.

Conversely, the buyer may be required to pay a substantially higher actual price than the agreed price when the buyer's native currency decreases in value vis-à-vis the seller's native currency during the delay period. The uncertainty underlying the above scenarios may thwart international commerce, particularly with respect to the formation of international contracts that routinely entail a delay period between the time of agreement and the time of performance. Accordingly, it is desirable to provide improved techniques for financial transactions.

### BRIEF DESCRIPTION OF THE DRAWINGS

Various embodiments in accordance with the present disclosure will be described with reference to the drawings, in which:

FIG. 1 illustrates an example environment in which aspects of the various embodiments can be implemented;

FIGS. 2A, 2B, 2C, 2D, and 2E illustrate example components for predicting a currency value for a period of time in accordance with various embodiments;

FIG. 3 illustrates an example approach to predicting a currency value for a period of time in accordance with various embodiments;

FIG. 4 illustrates an example model training pipeline that can be utilized in accordance with various embodiments;

FIG. 5 illustrates an example process for determining training data that can be utilized in accordance with various embodiments;

FIG. 6 illustrates an example process for training a model that can be utilized in accordance with various embodiments;

FIG. 7 illustrates an example environment in which aspects of the various embodiments can be implemented;

FIG. 8 illustrates an example process for predicting a currency value in accordance with various embodiments;

FIG. 9 illustrates an example process for iteratively updating a prediction model that can be utilized in accordance with various embodiments;

FIG. 10 illustrates an example process for providing recommendations based on a predicted currency value in accordance with various embodiments;

FIGS. 11A, 11B, and 11C illustrate an example of iteratively updating a prediction model in accordance with various embodiments;

FIG. 12 illustrates an example process for updating prediction values in accordance with various embodiments; and

FIG. 13 illustrates an example configuration of components of a device.

### DETAILED DESCRIPTION

Systems and methods in accordance with various embodiments of the present disclosure may overcome one or more of the aforementioned and other deficiencies experienced in conventional approaches to facilitating financial agreements in an electronic environment. In particular, various embodiments describe machine learning-based approaches for predicting future currency values and time-limited exchange rates that can be used to, for example, complete a financial transaction, a document agreement, and the like.

For example, in accordance with various embodiments, for each one of a plurality of time periods, a model (e.g., a currency prediction model such as a logistic regression model or another machine learning-based model) can be trained. The prediction models can be trained on market data that corresponds to each prediction models' period of time. The market data can be obtained from, for example, a trading venue, such as a stock exchange. That market data can include, for example, currency values, the prices of financial instruments such as shares, derivatives, commodities, and currencies. The market data for each time period can be separated into sets of data. For example, a first set of data, a second set of data, and a holdout set of data, where the first set of data includes market data received before a time period, the second set of data includes market data received during the time period, and the holdout set of data includes market data received during the time period and disjoint from the second set of data. The prediction models can evaluate the data to predict a currency value that satisfies a threshold level of change for a determined period of time. The value (e.g., a next value currency) can then be used to, for example, determine time-limited exchange rates that can be used for a purchase transaction, document agreements, trade strategies, business trading or transaction insides, etc.

Instructions for causing a computer system to facilitate financial transactions in accordance with the present disclosure may be embodied on a computer-readable medium. For example, in accordance with an embodiment, a backend system may train prediction models for a plurality of time periods. The prediction models can be trained on market data and market activity. The backend system can utilize models trained for different periods of time and other components to determine a predicted currency value and prediction score (also referred to as a confidence score) for each time period. For a selected time period, the prediction models can process the data to predict a currency value that satisfies a threshold level of change for a determined period of time. The value can then be used to, for example, determine time-limited exchange rates that can be used for a purchase transaction, document agreements, trade strategies, business trading or transaction insides, etc.

Embodiments provide a variety of advantages. For example, in accordance with various embodiments, machine learning-based approaches for predicting future currency values and time-limited exchange rates can be utilized by any system that attempts to optimize resource usage, including computing system resources such as financial transactions systems, trading systems, and the like. These systems may be utilized by, for example, trading platforms, banking platforms, financial platforms, and other environments where decisions based on a stable currency or other baseline may be needed. In accordance with various embodiments, by providing a system that predicts a stable currency value, the system can more efficiently utilize resource capacity. For example, predicting a currency value and a period of time for when the currency is stable, promotes international contract formation and financial transactions. In an example, assets may be purchased during the period of time. In another example, contract terms such as a purchase price for a purchase window can be determined and utilized. In yet another example, funds can be released at the predicted currency value at the end of the time period for the predicted currency value. In yet another example, a point-of-sale can be performed when a price satisfies a threshold associated with the predicted currency value. The process is improved by using machine learning-based techniques to optimize resource utilization of various resources. In certain embodiments, one or more trained models can be updated over at least one period of time using computer-readable information based on one or more performance metrics to ensure optimal usage of various resources. Further, approaches described herein advantageously provide for improved responses to market conditions. This can reduce idle resources, or other such inefficiencies of the resources, which can maximize resource usage and reduce cost.

Various other functions and advantages are described and suggested below as may be provided in accordance with the various embodiments.

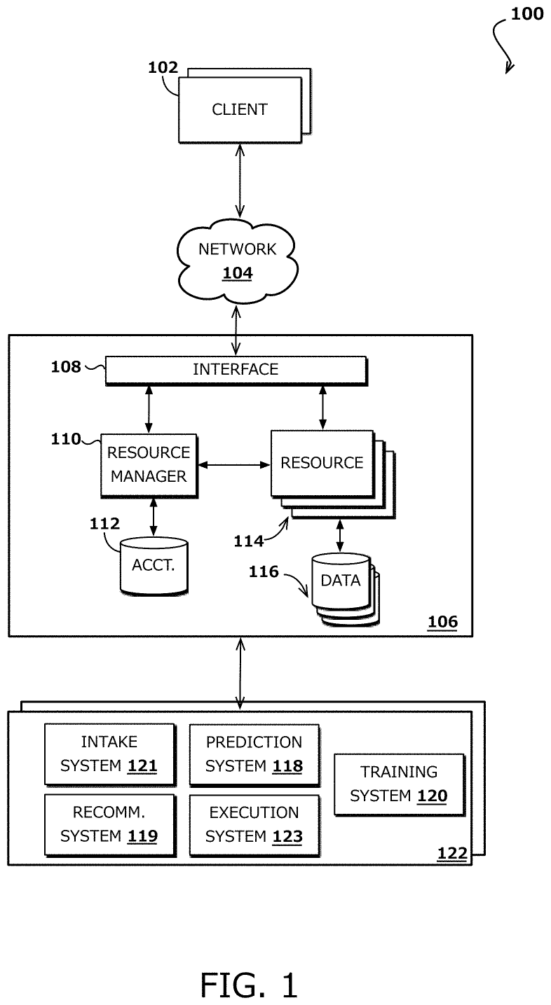

FIG. 1 illustrates an example environment 100 in which aspects of the various embodiments can be implemented. In this example, a user can utilize a client device 102 to communicate across at least one network 104 with a resource provider environment 106. The client device 102 can include any appropriate electronic device operable to send and receive requests or other such information over an appropriate network and convey information back to a user of the device. Examples of such client devices 102 include personal computers, tablet computers, smartphones, notebook computers, and the like. The user can include a person authorized to manage the aspects of the resource provider environment.

The resource provider environment 106 can provide financial support services for companies for various services. These services can include, for example, financial services, banking services, travel services, hotel services, flight services, payment services, security exchange services, among other such services where the fluctuations in the value of currency can be are considered. In certain embodiments, the resource provider of environment 106 can be an intermediary between a customer and financial broker service. The provider can, for example, assist a company by providing financial services for the company. This can include, for example, predicting currency values, determining time-limited exchange rates that can used for a purchase transaction, document agreements, providing trading strategies, providing business trading or transaction insights, etc. In various embodiments, the financial and other services can be performed in hardware and software, such as by using a trained model, a person, or combination thereof.

The network(s) 104 can include any appropriate network, including an intranet, the Internet, a cellular network, a local area network (LAN), or any other such network or combination, and communication over the network can be enabled via wired and/or wireless connections.

The resource provider environment 106 can include any appropriate components for receiving customer support requests and returning information or performing actions in response to those requests. It should be noted that although the techniques described herein may be used for a wide variety of users and requests, for clarity of presentation, examples of companies responding to a financial services request will be used. The techniques described herein, however, are not limited to financial services requests, and responses may be provided to requests from users who are not seeking financial services, and responses may be from any entity or person.

The resource provider environment 106 might include Web servers and/or application servers for predicting future currency values and time-limited exchange rates that can be used to, for example, complete a financial transaction, a document agreement, and the like. While this example is discussed with respect to the internet, web services, and internet-based technology, it should be understood that aspects of the various embodiments can be used with any appropriate services available or offered over a network in an electronic environment.

In various embodiments, resource provider environment 106 may include various types of resources 114 that can be used to facilitate financial services. The resources can include, for example, prediction system 118, recommendation system 119, training system 120, intake system 121, execution system 123, application servers operable to process instructions provided by a user or database servers operable to process data stored in one or more data stores 116 in response to a user request.

Intake system 121 is operable to obtain market data and currency data from various sources for various geographical locations.

Training system 120 is operable to use the market data and currency data to train one more models for various currency to determine currency values for periods of time that can be used to generate time-limited exchange rates.

Prediction system 118 is operable to forecast market data. For example, prediction system 118 can determine currency values for a particular period of time and time-limited exchange rates that can be used in accordance with embodiments described herein. A time-limited exchange rate can specify a time range for which a currency value maintains stable, or at least within a threshold amount of deviation.

Recommendation system 119 is operable to use the time-limited exchange rate to determine financial transactions or other recommendations. For example, based on the time-limited exchange rate, one or more currency values can be predicted. The predicted currency values can be used for a purchase transaction, a document agreement, a trading strategy, to recommend a financial trade, etc.

Execution system 123 is operable to facilitate one or more recommendations. For example, execution system 123 may initiate a purchase transaction, provide terms (e.g., expiration date) for an agreement, preform trades in accordance with a trading strategy.

The resources may be hosted on multiple server computers and/or distributed across multiple systems. Additionally, the components may be implemented using any number of different computers and/or systems. Thus, the components may be separated into multiple services and/or over multiple different systems to perform the functionality described herein. In some embodiments, at least a portion of the resources can be “virtual” resources supported by these and/or components.

In at least some embodiments, an application executing on the client device 102 that needs to access resources of the provider environment 106, for example, to initiate an instance of a next value currency service, time-limited exchange rate, etc., can submit a request that is received to interface layer 108 of the provider environment 106. The interface layer 108 can include application programming interfaces (APIs) or other exposed interfaces, enabling a user to submit requests, such as Web service requests, to the provider environment 106. Interface layer 108 in this example can also include other components as well, such as at least one Web server, routing components, load balancers, and the like.

When a request to access a resource is received at the interface layer 108 in some embodiments, information for the request can be directed to resource manager 110 or other such systems, service, or component configured to manage user accounts and information, resource provisioning and usage, and other such aspects. Resource manager 110 can perform tasks such as communicating the request to a management component or other control component which can be used to manage one or more instances of a next value currency service or time-limited exchange rate service as well as other information for host machines, servers, or other such computing devices or assets in a network environment, authenticate an identity of the user submitting the request, as well as to determine whether that user has an existing account with the resource provider, where the account data may be stored in at least one data store 112 in the resource provider environment 106.

For example, the request can be to instantiate a next value currency service or time-limited exchange rate service on host machine 122. The service (e.g., next value currency, time-limited exchange rate, etc.) can utilize intake system 121, execution system 123, prediction system 118, recommendation system 119, and training system 120, to predict currency values for a future period of time that can be used for a purchase transaction, document agreement, trading strategy, identify trends of behavior/events, generate visual summaries, provide business insights, etc. It should be noted that although host machine 122 is shown outside the provider environment, in accordance with various embodiments, one or more modules of the trend detection service can be included in provider environment 106, while in other embodiments, some of the modules may be included in the provider environment. It should be further noted that host machine 122 can include or at least be in communication with other components, for example, a customer support session manager, etc.

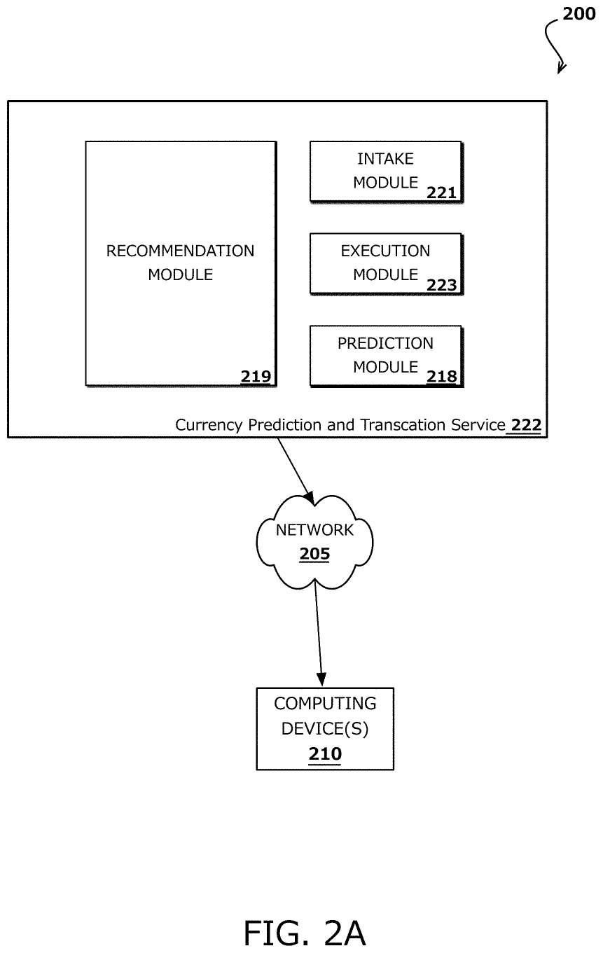

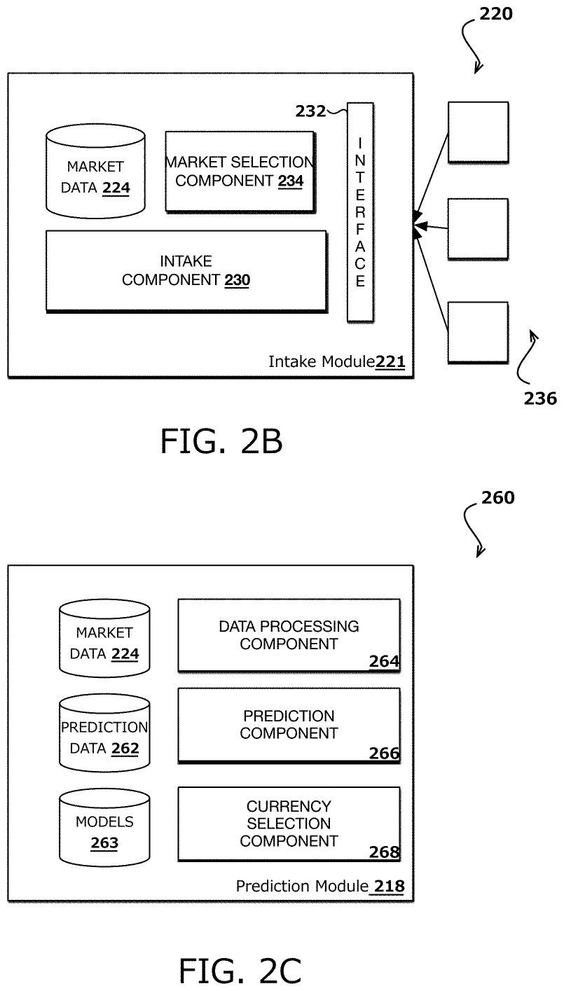

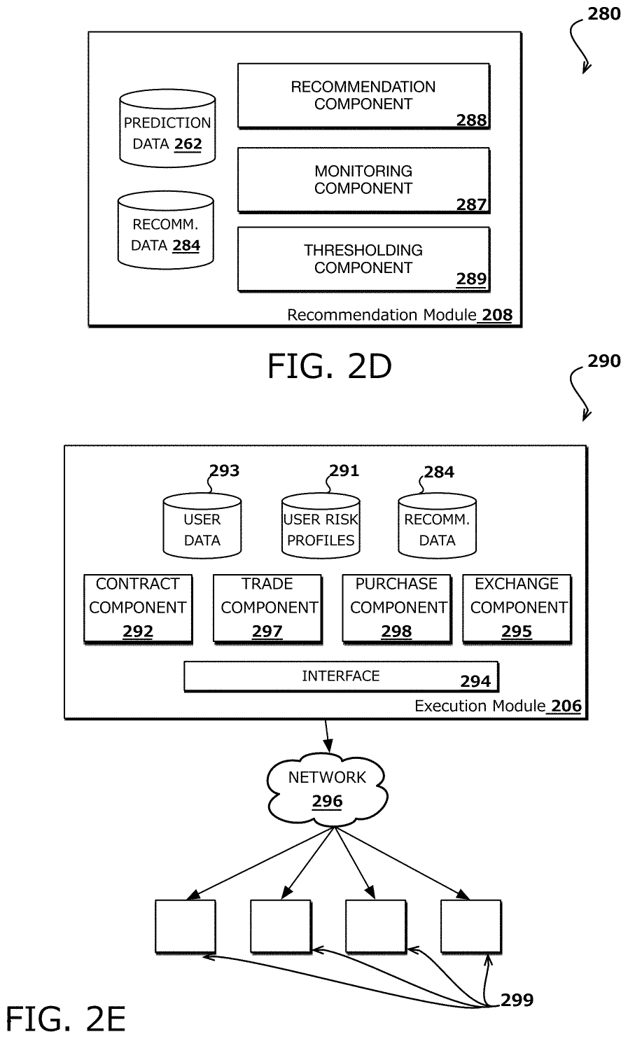

FIG. 2A illustrates components of an example environment 200 for predicting a currency value that satisfies a threshold level of change for a determined period of time in accordance with various embodiments. It should be understood that reference numbers are carried over between figures for similar components for purposes of simplicity of explanation, but such usage should not be construed as a limitation on the various embodiments unless otherwise stated. In this example, prediction module 218, recommendation module 219, intake module 221, and execution module 223 can be utilized to determine future currency values and time-limited exchange rates. As will be described further herein, intake module 221 is operable to obtain market data and currency data from various sources for various geographical locations, prediction module 218 is operable to forecast market data, recommendation module 219 is operable to use the time-limited exchange rate to determine financial transaction or other recommendations, and execution module 223 is operable to facilitate one or more recommendations.

Client computing devices 210 may interface with currency prediction and transaction service 222 (including recommendation module 219 and execution module 223 to conduct a transaction. The client computing devices 210 can be operated by one or more users. For example, a first user may deliver an asset in exchange for payment (e.g., seller, payee, supplier, vendor, retailer, venture capital recipient, etc.) and a second user may deliver payment in exchange for the asset or an interest in the asset (e.g., buyer, payor, customer, venture capitalist, etc.).

The one or more client computing devices may be personal or handheld computers having both input elements and output elements for communicating with the currency prediction and transaction service 222 over a network 205. For example, the one or more client computing devices 210 may include one or more of: a mobile telephone; a smartphone; a tablet; a phablet; a smartwatch; a wearable computer; a personal computer; a desktop computer; a laptop computer; a gaming device/computer; a television; and the like. This list is exemplary only and should not be considered as limiting. Any suitable client computing device for accessing currency prediction and transaction service 222 may be utilized. In at least some aspects, client computing devices 210 may be remotely located from one another; and in further aspects, client computing devices 210 may be located internationally.

Currency Prediction and transaction service 222 may be implemented by one or more server computing devices, e.g., within a cloud-based computing environment. In some aspects, the one or more client computing devices 210 and the one or more server computing devices may communicate over network 205. For example, network 205 may include multiple networks, e.g., an enterprise intranet, the Internet, etc. In this regard, network 205 may include a Local Area Network (LAN), a Wide Area Network (WAN), the Internet, and communication may be conducted via wireless and/or wired transmission mediums. In further aspects, the one or more client computing devices 210 may communicate with some components of the system via a local network (e.g., an enterprise intranet), whereas the one or more server computing devices may communicate with other components of the system via a wide area network (e.g., the Internet). In addition, the aspects and functionalities described herein may operate over distributed systems (e.g., a cloud-based computing environment), where application functionality, memory, data storage and retrieval and various processing functions may be operated remotely from each other over a distributed computing network, such as the Internet or an intranet.

As described, currency prediction and transaction service 222 may be implemented by one or more server computing devices. In an example, each server computing device may include at least a processing unit and a system memory for executing computer-readable instructions, e.g., a currency prediction and transaction application, for implementing the currency prediction and transaction service 222. Currency prediction and transaction service 222 may provide an interface to enable users to conduct transactions utilizing a predicted currency value. For instance, users may initiate, negotiate, agree, verify, and/or perform with respect to an electronic transaction or contract via the currency prediction and transaction service 222. For purposes of the present disclosure, while some transactions may not involve formation and performance of a contract in a formal sense, such transactions may be described in terms of the formation and performance of a contract for the sake of consistency and simplicity.

As described, a number of challenges create barriers to international transactions. Challenges include, for instance, fluctuations in the values of international currencies with respect to one another. This issue may be compounded when there is a delay between the time of agreement and the time of performance. The uncertainty underlying the above scenarios may thwart international commerce, particularly with respect to international purchase transactions and the formation of international contracts that routinely entail a delay period between the time of agreement and the time of performance. Implementation of the currency prediction and transaction service 222 addresses at least some of the above challenges to facilitate international transactions.

FIG. 2B illustrates example 220 of intake module 221 in accordance with an embodiment. Intake module 221 can include market selection component 234 and intake component 230. Market selection component 234 is operable to receive a selection of sources 236 for one or more geographic areas. The sources can include, for example, financial institutions such as trading venues, central banks, retail and commercial banks, internet banks, credit unions, savings, and loans associations, investment banks, investment companies, brokerage firms, insurance companies, and mortgage companies. The selected sources can be in response to user input specifying a particular geographic area, markets, and/or currency types. In certain embodiments, a configuration file or other instructions can be obtained that specifies one or more geographic areas, markets, and/or currency types. Example currency types include the U.S. dollar, British pound sterling, Japanese yen, Euro, Chinese yuan, etc.

Once the sources are identified, a variety of methodologies may be used to retrieve the relevant market data and market activity via interface 232, including but not limited to, data scrapes, API access, etc. Intake component 230 obtains market data associated with the selection. The market data can be stored in data store 224 or other appropriate data store. In an example, the market data can be stored in a format that can be consumed by one or more other components. For example, this may include but is not limited to a flat file, non-relational or relational database, or any other readily available electronic medium. The market data and/or activity can include, for example, fiat currency values (e.g., currency backed by a particular government issuing the currency), the prices of financial instruments such as shares, derivatives, commodities and currencies, the latest bid price (e.g., the price at which a dealer is prepared to buy securities or other assets), the latest ask price (e.g., the lowest price a seller of a stock is willing to accept for a share of that stock), the time of the last quote and trade, the price and size of the last sale, etc.

In certain embodiments, intake component 230 can process the data to determine, for example, currency values and other information such as a timestamp, a source, etc. In certain embodiments, intake component 230 can separate or otherwise split currency values into one or more sets. The sets can be based on one or more criteria. For example, the sets can be based on when the currency value was determined. In an example, this can include a set of currency values received during a period of time, a set of currency values received before the period of time, a set of currency values received after the period of time, etc. Intake component 230 in various embodiments can flag or otherwise group currency values to be included in a holdout set of currency values, where currency values in the holdout set are disjoint from currency values in the other sets.

FIG. 2C illustrates example 260 of prediction module 218 in accordance with an embodiment. Prediction module 218 includes data processing component 264, prediction component 266, and currency selection component 268. In this example, currency selection component 268 obtains a selection of one or more currencies. The selection can, for example, identify a currency for which a prediction is desired. For example, a user may indicate they want to know the currency value of the U.S. dollar for the next thirty minutes.

Data processing component 264 is operable to associate market data to an appropriate time horizon. For example, data processing component 264 can obtain recent historical or forecasted data, and align the properties to a model's input requirements. In another example, data processing component 264 can obtain market data for a particular period of time, and can separate the data into sets of data. For example, a first set of data, a second set of data, and a holdout set of data, where the first set of data includes market data received before a time period, the second set of data includes market data received during the time period, and the holdout set of data includes market data received during the time period and disjoint from the second set of data. In various embodiments, the data can be formatted in a time descending manner, and data that satisfies a threshold, such as the top number of data points to satisfy a defined time horizon of Y can be selected. The processed data can be stored in, for example, data store 224 or other appropriate data store.

Prediction component 266 is operable to process the collected market data in data store 224 using trained machine-learning models stored in, for example, data store 263. As will be described further herein, the models can be trained for particular currencies and can be used to predict a future currency value which can be used to determine time-limited exchange rates that can be used to determine, e.g., a next trade price or trade volume. This can be accomplished using any number of frequency or time domain scenarios. In an example, a model may forecast/predict the next X time interval of market data (e.g., currency values) by analyzing the input of the previous Y time interval of data. For illustrative purposes, this can be represented as X=Model(Y), where X is the forecasted market data and Y is an array of formatted market data with a length equal to the selected time horizon. Prediction component 266 can process the data to predict a currency value or other appropriate value that can be stored in data store 262 and/or utilized for other such purposes.

FIG. 2D illustrates example 280 of recommendation module 219 in accordance with an embodiment. In this example, recommendation module 208 can include, recommendation component 288, monitoring component 287, and thresholding component 289. In accordance with an embodiment, recommendations can be executed based on whether particular conditions or thresholds are satisfied. Monitoring component 287 can monitoring predication data in data store 262 to determine when, for example, prediction data is received or values associated with the prediction data (e.g., predicted currency values, prediction scores) otherwise changes a threshold amount. The thresholds can be static or dynamic. In an embodiment, thresholding component 289 can set the various thresholds. The thresholds may be manually adjusted by a user, or automatically adjusted in accordance with market conditions and/or one or more purchase/trading strategies.

Recommendation component 288 is operable to analyze the currency value and associated prediction score (also referred to as a confidence score) to generate one or more financial transaction recommendations. For example, for a particular currency value, a prediction score can be compared to a threshold prediction score. In the situation the prediction score satisfies the threshold prediction score, one or more financial transaction recommendations can be determined based on the comparations. The recommendations for a given time period can include, for example, a list of assets to buy, hold, and/or sell, specific time intervals to execute trades, a particular volume to trade, a particular trade action to execute, etc. The recommendations may be executed using execution module 206 illustrated in example 290.

FIG. 2E illustrates example 290 of execution module 206 in accordance with an embodiment. In this example, execution module 206 can include contract component 292, trade component 297, and exchange component 295. Components 292, 297, and 298 can access user data store 293, user risk profiles 291 or other user account or user profile information, and recommendation data 284. Interface 294 can include APIs enabling a user or appropriate computing component to execute the recommendations over at least one network 296 with one or more entities 299, including, for example, financial institutions, banking institutions, etc. For example, interface 294 can be utilized to execute digital contracts and completing digital transactions utilizing a next currency value and/or time-limited exchange rate.

The recommendations may be executed in accordance in with one or more risk profiles or other user account or user profile information. In an embodiment, a risk profile can specify rules for when particular financial transactions are to be executed. It should be noted that a risk profile may be referred to as a purchase profile or a trade profile. The rules may specify particular thresholds (e.g., currency thresholds, time thresholds, etc.), trade volume for a financial security when at least one threshold is satisfied, financial securities to buy, sell, and/or hold when at least one threshold is satisfied, etc. For instance, a trading strategy can include trading on recommendations predicted with an estimated error rate less than a particular threshold or percentage, or the volume, or cost per unit, or total cost. Trades can be executed based on the defined strategy using, for example, API calls, an agent, automated phone calls, etc. If a trade order is partially successful, the data can be recorded for both the successful and unsuccessful orders. This trade can then be retried, held, or dropped based on the pre-configured trading strategy.

In an embodiment, interface 294 can provide an interface to enable users to conduct a purchase transaction such as an international transaction utilizing a next currency value. For example, contract component 292, trade component 297, or purchase component 298 can allow users to initiate, negotiate, agree, verify, and/or perform with respect to an electronic transaction or contract via execution module 206.

In an example, contract component 292 may implement an interface that enables users to enter into a contract such as an international contract. The contract, in this example, can include a digital agreement that is formed, verified, and/or enforced within a computer-implemented environment. The contract can involve at least one party located in a remote location, e.g., a different nation from another party. The contract may involve a first entity providing a first currency to a second entity in exchange for a second currency, where the amount of the first currency provided and the second currency received is based on a time-limited exchange rate. In another example, contract component 292 can receive a selection to purchase an asset at a price. A contract can be generated that includes as the price a next currency value. As described, the next currency value can include a duration of time for which the currency value is valid, where offer and acceptance is based on the duration of time. For example, the offer at the next currency value may be valid during the duration of time, and expire outside the duration of time.

In yet another example, trade component 297 is operable to complete one or more financial trades in accordance with a user risk profile or other user account or user profile information, recommendation data, next currency value, and/or prediction score. The financial trades that may be executed include, for example, a list of assets to buy, hold, and/or sell, specific time intervals to execute trades, a particular volume to trade, a particular trade action to execute, etc. The financial trades can be executed at the predicted currency value, and may be executed during a performance time for executing all or a portion of the trades. The data associated with a trade of any type, successful or otherwise, can be stored and can be used to refine the trading strategy or simulate other scenarios based on any number of factors.

In yet another example, purchase component 298 is operable to perform a purchase transaction using a predicted currency value and/or time-limited exchange rate. For example, a request to initiate a purchase transaction can be received. The purchase transaction can be for an asset, goods, services, etc. A document can be generated that includes the price for the purchase transaction. The price can be, for example, the predicted currency value and the price can be valid for a determined period of time (e.g., a performance time) associated with the predicted currency value. For example, during the period of time, parties may negotiate and/or perform with respect to the purchase transaction.

For instance, a first user may accept the asking price or offer a price for an asset. In this example, the first user may be associated with a secure wallet, which may be an extension of a client app or otherwise hosted by or associated with a currency prediction and transaction platform. In some cases, the first user may fund the wallet with predicted currency and/or other currency, which may be any foreign currency, national currency, or domestic currency (e.g., U.S. dollar, British pound sterling, Japanese yen, Euro, Chinese RMB, Argentine peso, Australian dollar, Iraqi dinar, etc.), digital currency or cryptocurrency (e.g., Bitcoin®, Litecoin®, Ethereum®, Peercoin®, etc.), precious metal (e.g., gold, silver, etc.), and the like. The wallet may be in communication with exchange component 295. Exchange component 295 may include a converter for generating time-limited exchange rates based on predicted currency values. As described, predicted currencies may be determined in near real time, for different currencies, such that the value of each predicted currency is based on a current, real-world market and currency data.

In some cases, as described, users may negotiate a price and/or a performance time for conveying all or a portion of asset. In some cases, the asset may be tangible real or personal property and conveyance of the asset may include transferring title and possession of the asset. In other cases, the asset may be intangible and an interest or equity in the asset may be conveyed. Whether the asset is tangible or intangible, the users may elect to enter into a contract for conveyance of the asset. The contract is formed upon agreement between the users as to the terms for conveying the asset. Such terms include, at least, agreement as to price, and may include agreement as to performance time. Upon entering into a contract, the contract may be associated with (e.g., tagged, linked, marked, etc.) the period of time associated with a predicted currency value. For instance, monitoring changes in a time-limited exchange rate can be used to determine when and if fluctuations in international currencies impact the contract price. As discussed, a delay period between formation and execution of a contract (e.g., payment) may include time required to verify title to property, time required to secure financing, time required to manufacture the asset, and the like. For some transactions, the delay period may be a matter of minutes, whereas in other transactions the delay period may be weeks or months. As should be appreciated, the longer the delay period, the more likely that value fluctuations in the currency market may affect the actual price delivered by a seller and received by a buyer. As a result of this increased risk, transactions involving longer delay periods may be stymied. It is with respect to the delay period and the attendant market hindrances that the present disclosure is directed. Accordingly, the time-limited exchange rate can be used to determine the change in the contract price based on fluctuations in international currencies. A contract clause in the contact can specify, for example, that the contract is void or some other condition is triggered if a predicted price as determined using the time-limited exchange rate does not satisfy a change in price threshold. In another example, a contract clause may trigger payment, conveyance of an asset, etc., when, for example, the predicted price changes a threshold amount, at the performance time (e.g., at the end of the period of time), etc.

In various embodiments, trades may be simulated. In this example, simulated trades can be recorded as if they were executed, and the recorded trades can be used for historical tracking or analysis.

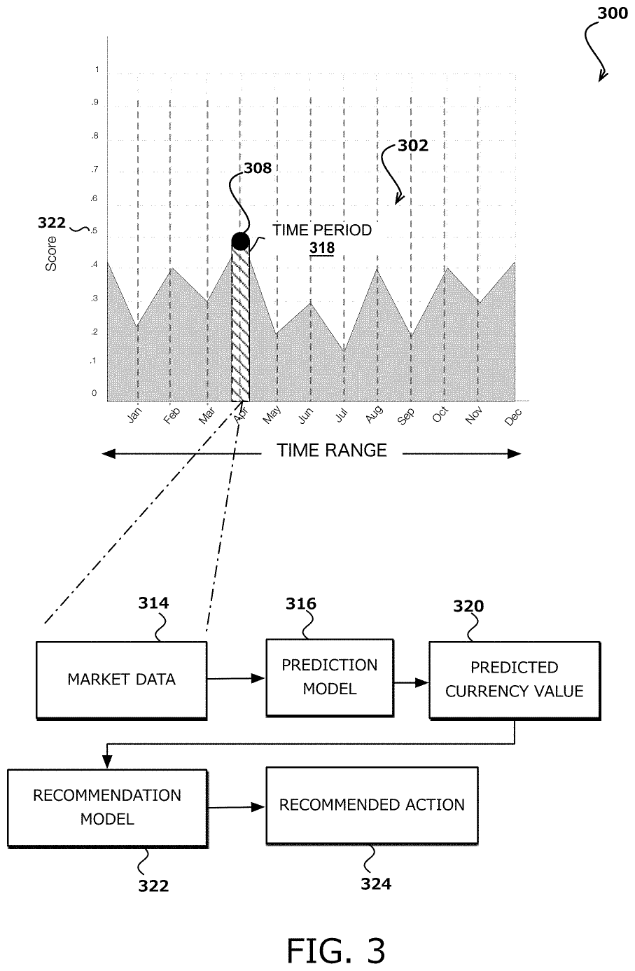

FIG. 3 illustrates an example approach 300 to recommending financial transactions based on predicted currency values in accordance with various embodiments. In this example, graph 302 illustrates a graphical representation of currency values determined from market and/or currency data from various sources for a particular geographical location. The x-axis represents time and the y-axis represents a level of confidence. As shown, the x-axis illustrates a time range of one year, and a time period of a week every four weeks. It should be noted that the time range, time period, and time period interval can be other amounts of time, and the times used are for example purposes. For example, the time period and/or time period interval can be amounts measured in, e.g., real-time, seconds, minutes, hours, daily, etc. The y-axis can be represented as a number, e.g., a number between zero and one, a number between zero and 100, a percentage, etc. Each number can correspond to a confidence score (also referred to as a prediction score) that represents the likelihood of a predicted currency value being the actual currency value for a period of time. Dot 308 represents a currency value for a particular time period.

As part of the process for predicting currency values and determining time-limited exchange rates, market data 314 is obtained. The market data can be obtained from, for example, financial institutions such as trading venues, central banks, retail and commercial banks, internet banks, credit unions, savings, and loans associations, investment banks, investment companies, brokerage firms, insurance companies, and mortgage companies, computer-readable data sent between one or more computers (e.g., financial transaction data, instructions, code, etc.), or otherwise obtained. That market data can include, for example, currency values, the prices of financial instruments such as shares, derivatives, commodities and currencies. The market data for each time period can be separated into sets of data. For example, a first set of data, a second set of data, and a holdout set of data, where the first set of data includes market data received before a time period, the second set of data includes market data received during the time period, and the holdout set of data includes market data received during the time period and disjoint from the second set of data. In various embodiments, the period of time can be, for example, predetermined, user-specified, etc.

Prediction model 316 is trained on the first set of data and the second set of data associated with time period 318 to predict (e.g., determine or compute) a currency value (e.g. a next value currency score) and a prediction score for the currency value. The prediction model 316 can be used to evaluate each currency value in the holdout set of currency values to determine (e.g., compute or predict) a set of next value currency scores corresponding to the holdout set of currency values and a prediction score for each of the predicted currency values, where a prediction score can quantify the likelihood of a predicted currency value being the actual currency value for a period of time.

The set of currency values and prediction scores can be processed to determine representative currency value for time period 318 based on the set of currency values and respective associated prediction scores. For example, the representative currency value for the time period can correspond to the currency value associated with a prediction score satisfying a prediction score threshold. In an example, the representative currency value can correspond to the currency value associated with a prediction score in the 95th percentile prediction score. In certain embodiments, the representative currency value may be an average or the median of currency values. For example, currency values associated with a period of time can be split into a plurality of groups of first sets of currency values, second sets of currency values, and holdout sets of currency values. A representative currency value can be determined for each holdout set of currency values of the plurality of groups to obtain a set of representative currency values, and the representative currency value for the period of time can correspond to one of the average or median of the values. In yet another example, representative currency values from the set of representative currency values that correspond to a prediction score satisfying a threshold prediction score can be selected, and the selected currency values can be averaged. The average of the currency scores can correspond to the representative currency score for the period of time.

A predicted currency value 320 for a future time can be determined based on the representative currency score for the period of time. For example, the predicted currency value can correspond to the representative currency value for time period 318. The future time can correspond to a predetermined period of time outside time period 318.

In an embodiment, representative currency scores from a plurality of prediction models trained over a plurality of previous time periods can be obtained. A trend detection model can be applied to set of representative currency scores to determine whether representative predicted currency value 320 associated with time period 318 is associated with an anomalous event. For example, using the set of representative currency scores, a model can generate data to fit the distribution of the scores. In an embodiment, the model can be a Gaussian mixture model that can generate a set of points which approximately fit the set of representative confidence scores. In the situation a representative confidence score does not fit the set of points by a threshold amount, or the model otherwise detects an outlier, or other condition is satisfied, an anomalous event may be detected. In any situation, event information for the period of time can be stored for use in one or more other purposes. For example, in the situation an anomalous event is detected, an alert for the anomalous event can be generated and presented to an appropriate entity. It should be noted that various other models can be applied as well within the scope of the various embodiments, such as, e.g., a change point detection model, RANSAC, or other outlier detection model.

The predicted currency value can be analyzed using recommendation model 322 to determine a recommended action 324. For example, based on the predicted currency value, time-limited exchange rates can be determined. The time-limited exchange rates can be used for a purchase transaction, document agreements, trade strategies, business trading or transaction insides, to determine a next trade price or trade volume, etc.

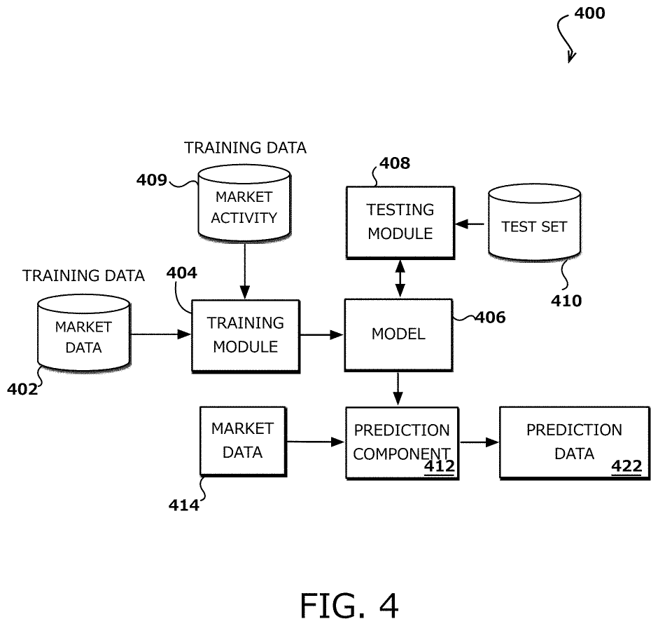

As described herein, market data and market activity can be used to train a model (e.g., a prediction model). Example 400 of FIG. 4 illustrates an example classification pipeline that can be utilized in accordance with various embodiments. In this example, market data 402 and market activity 409 is obtained that can be used to train model 406. Training data 402 and 409 can include for example, fiat currency values (e.g., currency backed by a particular government issuing the currency), the prices of financial instruments such as shares, derivatives, commodities and currencies, the latest bid price (e.g., the price at which a dealer is prepared to buy securities or other assets), the latest ask price (e.g., the lowest price a seller of a stock is willing to accept for a share of that stock), the time of the last quote and trade, the price and size of the last sale, etc. As described, the market data and/or activity can include timestamp records, etc.

In order to function as training data for one or more models (e.g., a logistic regression model or other machine learning-based model), at least some of the market data and/or market activity can be associated with data that indicates a label, type, or classification of the data. The classifications in at least some embodiments can be selected from a set of classifications, or sub-classifications used to identify various types of currency, currency value, timing information, market conditions, etc. For example, for a period of time, training data 402 can include currency values received during a period of time and training data 409 can include market activity for that period of time.

The training data can be labeled using one of any number of approaches. For example, the training data can be labeled using a feature extractor to extract features of the training data, such as currency values, timestamp, currency type, and a category model to perform the classification of the training data based on the extracted features. A feature extractor can extract, for example, the timestamp associated with each currency. A category model can label each currency based on the timestamp, currency type, and the period of time. The category model may be trained, for example, on data from a company database that has been annotated by human experts. The output of the category model can be, for example, a one-of-k vector (where one element of the vector is true, or 1 and the remaining values are false or 0) indicating which category the data belongs to (of k possible categories). For example, the feature extractor can extract the timestamp for each currency and the category model can process the timestamp and categorize the currency as being received before the time period or during the time period. In another example, the timestamp for each currency can be compared to the time period. Currency values associated with a timestamp before the time period can be labeled one. Currency values associated with a timestamp during the time period can be labeled zero.

In some embodiments, a portion of the training set will be retained as testing set 410 to use to test the accuracy of the trained model.

In this example, the training data is accessible to a training module 404 which can feed the data to model 406 (e.g., a machine learning-based model) to train the network. Model 406 can include, for example, one of a logistic regression, Naïve Baye, random forest, neural network, or support vector machines (SVMs), stacked long short-term memory (LSTM) network, etc.

The classification data can be provided to the model so the model can learn features associated with the market data and market activity. The network can then learn various combinations or relations of features of the market activity, such that when a currency value is processed with the trained model, the model can recognize the features and output the appropriate prediction score for the currency value. In an embodiment, the prediction score can quantify the likelihood of a predicted currency value being the actual currency value for a period of time.

In certain embodiments, once at least the initial training has completed, a testing module 408 can utilize the testing set 410 to test the trained model. Since the testing data already includes classification data, such as data operable to label, identify, or otherwise indicate ground truth, the classifications and predictions generated by the model can be compared against that data to determine the accuracy of the model, both overall and for different categories of currency. In certain embodiments, the testing data can also be used to train the model further. The results can be analyzed and if the results are acceptable, such as where the accuracy at least meets a minimum accuracy threshold for some or all of the classifications and predictions, the model can be provided to classifier 412 that is able to process market data 414, and generate prediction data 422 (e.g., a currency value and prediction score for a future period of time.

In some embodiments, the training data 402 and 409 can be used as training data for one of a logistic regression, Naïve Baye, random forest, neural network, or support vector machines (SVMs), convolutional recurrent neural network, deep neural network, or other types of neural networks or models, and/or combination of any of the above models, stacked models and heuristic rules. Various other approaches can be used as well as discussed and suggested elsewhere herein.

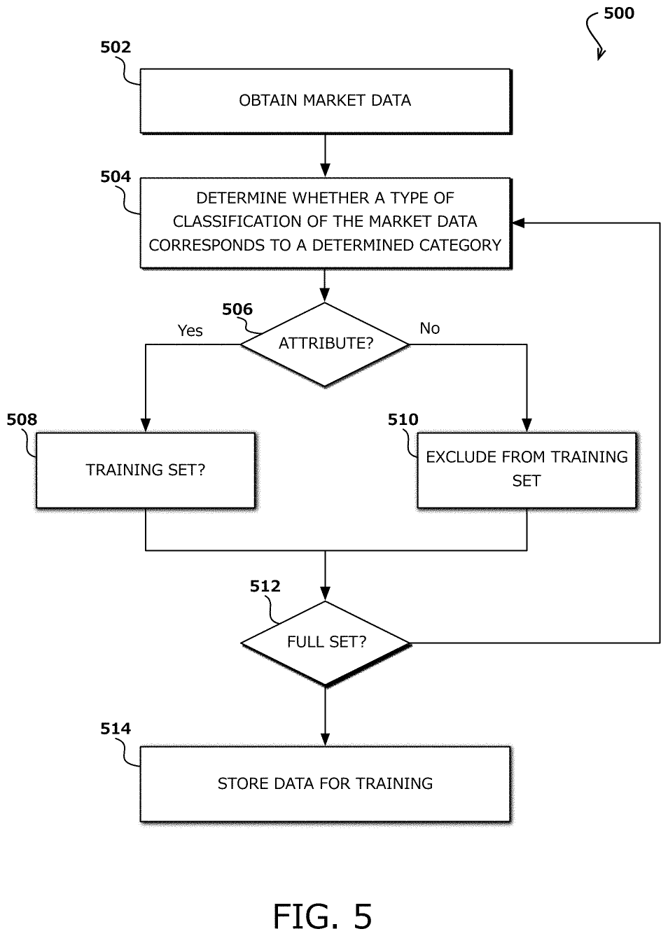

FIG. 5 illustrates an example process 500 for determining training data that can be utilized in accordance with various embodiments. It should be understood that, for any process discussed herein, there can be additional, fewer, or alternative steps, performed in similar or different orders, or in parallel, within the scope of the various embodiments unless otherwise stated. In this example, market data and market activity can be obtained 502 for analysis. The data can be obtained from, for example, various sources for various geographical locations and can include fiat currency values (e.g., currency backed by a particular government issuing the currency), the prices of financial instruments such as shares, derivatives, commodities and currencies, the latest bid price (e.g., the price at which a dealer is prepared to buy securities or other assets), the latest ask price (e.g., the lowest price a seller of a stock is willing to accept for a share of that stock), the time of the last quote and trade, the price and size of the last sale, computer-readable data between one or more computers (e.g., currency values and types, instructions, code, etc.), or otherwise obtained. In certain embodiments, the training data can be from one or more data stores maintained directly or indirectly by a currency prediction and transaction service provider, resource provider, or a third-party, or from multiple sources, among other such options.

A timestamp associated with the data (or other information associated with data) can be used to determine 504 whether a type of classification of currency corresponds to a category and includes particular attributes, or types of attributes, for which a model (e.g., logistic regression, neural network, or other machine learning algorithm) can be trained. For example, using a timestamp for the currency values, it can be determined whether the value for the currency occurred before, during, or after a selected period of time, and, e.g., whether that currency is associated with particular categories of market activity, etc.

If it is determined 506 that a currency exhibits the attribute (e.g., time, currency type, etc.) for a particular category (e.g., received before, during, after a period of time), then that currency can be added 508 to the training set. In an embodiment, the training set can include different sets of currency. For example, the training set can include a set of currency received before a time period and a set of currency received during the time. If not, that currency can be excluded 510 from the training set. As mentioned elsewhere herein, in at least some embodiments, some of the currency may be instead added to a testing set, a holdout set, or not added to any set but may have the attribute classification associated therewith. Currency in the holdout set can include currency received during the time period and disjoint from the other currency in the training set.

If it is determined 512 that a full training set has been obtained, using any appropriate criterion as discussed or suggested herein, such as a threshold number of currency values for a period of time, then the training set generation can complete, and the currency values can be stored 514 for training and other purposes. Otherwise, the process can continue until a full set is obtained, all of the relevant data is analyzed, or another stop condition is satisfied.

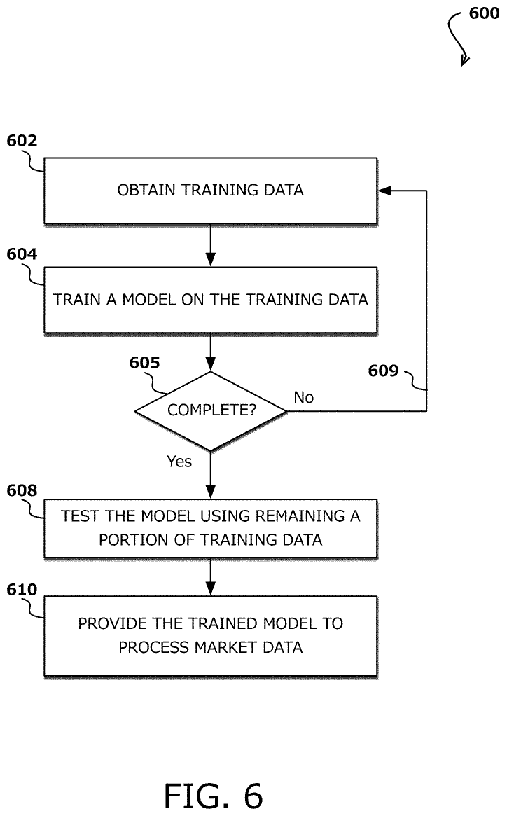

FIG. 6 illustrates an example process 600 for training a prediction model that can be utilized in accordance with various embodiments. Once the training data is obtained 602, the training data can be provided as input to a model training process. The training data can include, for example, market data and market activity that indicates a type or classification for a specific category of currency and market conditions, timestamp records, and the like. As described, the type or classification for a specific category can include currency type, whether the currency value was determined before, during, or after a particular time period. Thus, according to various embodiments, the training data can include a set of currency values received before a time period and a set of currency values received during the time period as well as associated market activity.

In the example of logistic regression, or other machine learning-based model, the model can be trained 604 on the training data to predict a currency value that satisfies (e.g., is within) a threshold level of change for a determined period of time. The value (e.g., a next value currency) can then be used to, for example, determine time-limited exchange rates that can be used for a purchase transaction, document agreements, trade strategies, business trading or transaction insides, etc. For example, the model can learn various combinations or relations of currency to market activity such that when currency values are processed for particular market activity with the trained model, the trained model can recognize the features and output prediction information, including, for example, a predicted currency value, a prediction score or other such score, although various other outputs can be utilized as well within the scope of the various embodiments.

If it is determined 605 that a stop condition has been met so that training should be completed, such as by processing the entire training set, then the trained model can be provided to process, for example, currency for a particular period of time. As discussed herein, the model might first go through a process to test 608 using at least some of the training classified with the attribute type from earlier steps of the process. If the training is not complete, then the training process can continue 609 until a trained model is obtained. Thereafter, the trained model can be provided 610 to process currency associated with a particular period of time to predict a currency value and prediction score that satisfies a threshold level of change for a determined period of time.

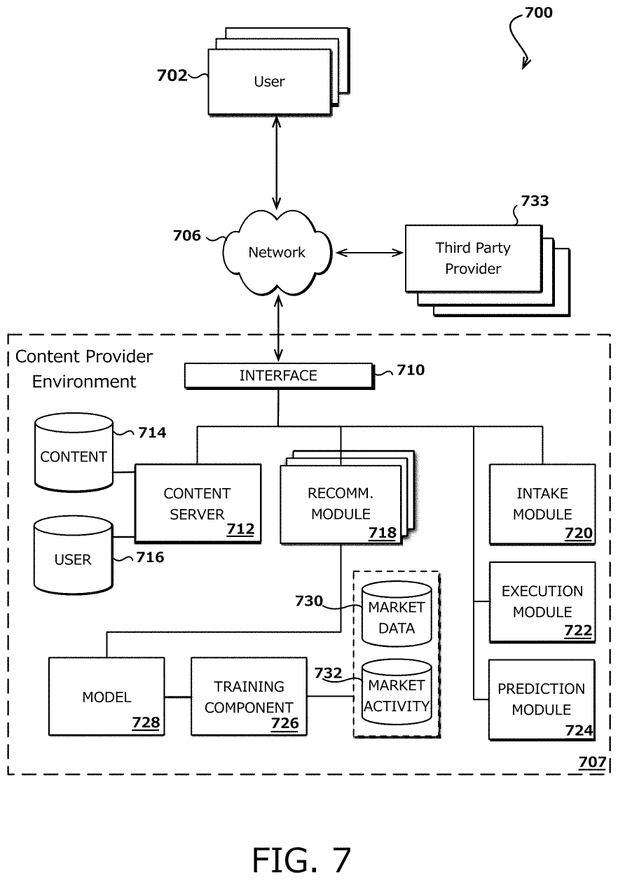

FIG. 7 illustrates an example environment 700 in which aspects of the various embodiments can be implemented. In this example, users can utilize an application or interface, such as a browser, executing on user device 702 to communicate with a currency prediction and transaction service over at least one network 706. The user device 702 can be any appropriate computing device capable of requesting, receiving, and/or presenting content, such as may include a desktop computer, a thin client device or “dummy terminal,” a smartphone, an e-book reader, a tablet computer, a notebook computer, a personal data assistant, a video gaming console or controller, a smart television, a wearable computer (e.g., a smartwatch or glasses), or a portable media player, among others.

User device 702 is in communication with a resource provider 707 via the at least one network 706. The at least one network can include a wired and/or wireless network, as may include the Internet, a cellular network, a local area network (LAN), an Ethernet, an Intranet, and the like. The user device 702 may have varied local computing resources, such as may include central processing units and architectures, memory, mass storage, graphics processing units, communication network availability and bandwidth, etc.

Resource provider 707 can provide financial transaction services. These services can include, for example, financial services, banking services, travel services, hotel services, flight services, payment services, security exchange services, among other such services where the fluctuations in the value of currency come are considered. In certain embodiments, provider 707 can be an intermediary between a customer and a company, such as third-party provider 733. For example, third-party provider 733 can utilize resource provider 707 to provide or otherwise execute financial transactions such as digital contracts, completing digital transactions utilizing a next currency value and/or time-limited exchange rate, and other services described herein.

Purchase and/or trading strategy information can be received to an interface and/or networking layer 710 of the resource provider 707. The interface and/or networking layer can include any of a number of components known or used for such purposes, as may include one or more routers, switches, load balancers, Web servers, application programming interfaces (APIs), and the like.

The information can be stored in content data store 714 and as well as information associated with the user in in profile data store 716 until such information is ready to be processed. Other information may be obtained including, for example, market data and market activity. For example, intake module 720 can receive a selection a selection of sources for one or more geographic areas. The sources can include, for example, financial institutions such as trading venues, central banks, retail and commercial banks, internet banks, credit unions, savings, and loans associations, investment banks, investment companies, brokerage firms, insurance companies, and mortgage companies. The selected sources can be in response to user input specifying a particular geographic area, markets, and/or currency types. In certain embodiments, a configuration file or other instructions associated with the purchase and/or trading strategy can be obtained that specifies one or more geographic areas, markets, and/or currency types.

Once the sources are identified, a variety of methodologies may be used to retrieve the relevant market data and market activity, including but not limited to, data scrapes, API access, etc. Intake component 230 obtains market data associated with the selection. The market data can be stored in data store 730 and 732 or other appropriate data store. The market data and/or activity can include, for example, fiat currency values (e.g., currency backed by a particular government issuing the currency), the prices of financial instruments such as shares, derivatives, commodities and currencies, the latest bid price (e.g., the price at which a dealer is prepared to buy securities or other assets), the latest ask price (e.g., the lowest price a seller of a stock is willing to accept for a share of that stock), the time of the last quote and trade, the price and size of the last sale, etc.

In certain embodiments, intake module 720 can process the data to determine, for example, currency values and other information such as a timestamp, a source, etc. In certain embodiments, intake module 720 can separate or otherwise split currency values into one or more sets. The sets can be based on one or more criteria. For example, the sets can be based on when the currency value was determined. In an example, this can include a set of currency values received during a period of time, a set of currency values received before the period of time, a set of currency values received after the period of time, etc. Intake module 720 in various embodiments can flag or otherwise group currency values to be included in a holdout set of currency values, where currency values in the holdout set are disjoint from currency values in the other sets.

Prediction module 724 obtains a selection of one or more currencies. The selection can, for example, identify a currency for which a currency value prediction is desired. For example, a user may indicate they want to know the future currency value of the U.S. dollar for the next thirty minutes. Prediction module 724 processes market data in data store 730 using trained machine-learning models.

Recommendation module 718 can execute one or more recommendations based on whether particular conditions or thresholds are satisfied. For example, recommendation module 718 is operable to analyze predicted currency values and associated prediction scores to generate one or more financial transaction recommendations. For example, for a particular currency value, a prediction score can be compared to a threshold prediction score. In the situation the prediction score satisfies the threshold prediction score, one or more financial transaction recommendations can be determined based on the comparations. The recommendations for a given time period can include, for example, a list of assets to buy, hold, and/or sell, specific time intervals to execute trades, a particular volume to trade, a particular trade action to execute, etc. The recommendations may be presented to a user via content server 712 or another appropriate component.

The recommendations may be executed using execution module 722. As described herein, the recommendations may be executed in accordance in with one or more risk, strategy, purchasing, or trading profiles, or other user account or user profile information. In an embodiment, these or a combined profile can specify rules for when particular financial transactions are to be executed.

Training component 726 in accordance with embodiments described herein is operable to use market data 730 and market activity data 732 to train one more models 728 for various currency to determine currency values for periods of time that can be used to generate time-limited exchange rates and other such values. For example, training component 726 can obtain market data and market activity data from data stores 730 and 732. The data can be organized into one or more sets. The sets can be based on one or more criteria. For example, the sets can be based on when the currency value was determined. In an example, this can include a set of currency values received during a period of time, a set of currency values received before the period of time, a set of currency values received after the period of time, etc. For each one of a plurality of periods of time, a model (e.g., a prediction model) can be trained. Each model can be trained on market that correspond to each models' period of time, and the trained models can be stored in an appropriate data store.

Once a model for a period of time is trained, a model can be used to evaluate each currency value in the holdout set of currency values to determine a set of next value currency scores corresponding to the holdout set of currency values and a prediction score for each of the predicted currency values, where a prediction score can quantify the likelihood of a predicted currency value being the actual currency value for a period of time. The next value currency score can satisfy a threshold level of change for a determined period of time. The value (e.g., a next value currency) can then be used to, for example, complete a financial transaction, a document agreement, and the like.

In accordance with various embodiments, additional or alternative components and elements can be used in such a system in accordance with the various embodiments. Accordingly, it should be noted that additional services, providers, and/or components can be included in such a system, and although some of the services, providers, components, etc., are illustrated as being separate entities and/or components, the illustrated arrangement is provided as an example arrangement and other arrangements as known to one skilled in the art are contemplated by the embodiments described herein. In accordance with various embodiments, the various components described herein may be performed by any number of server computing devices, desktop computing devices, mainframe computers, and the like. Individual devices may implement one of the components of the system. In some embodiments, the system can include several devices physically or logically grouped to implement one of the modules or components of the system. For example, the system can include various modules and components combined on a single device, multiple instances of a single module or component, etc. In one specific, non-limiting embodiment, recommendation module 718, execution module 722, and prediction module 724, can execute on one device and training component 726 can execute on another device, and intake module 720 can execute on yet another device. In another embodiment, the components can execute on the same device or other combination of devices.

In some embodiments, the features and services provided by the system may be implemented as web services consumable via a communication network. In further embodiments, the system is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

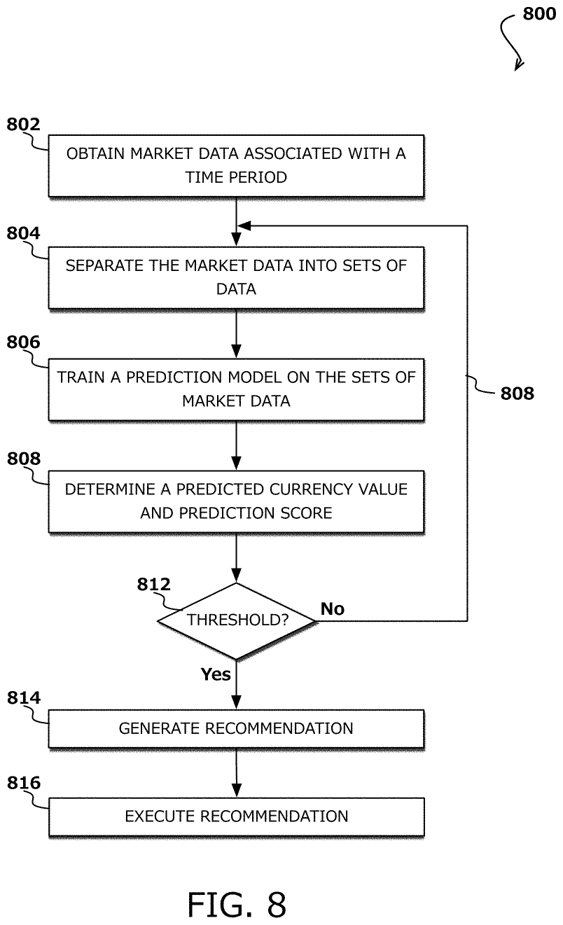

FIG. 8 illustrates an example process 800 example process for predicting a currency value in accordance with various embodiments. In this example, market data and market activity for a time period is obtained 802. The data can be obtained from, for example, a trading venue, such as a stock exchange. That market data can include, for example, currency values, the prices of financial instruments such as shares, derivatives, commodities, and currencies. The market data can be separated 804 or otherwise split into sets of data. For example, a first set of data, a second set of data, and a holdout set of data, where the first set of data includes market data received before a time period, the second set of data includes market data received during the time period, and the holdout set of data includes market data received during the time period and disjoint from the second set of data. A prediction model 806 is trained on the first set of data and the second set of data associated with a time period to predict a currency value (e.g. a next value currency score) and a prediction score for the currency value. The prediction model can be used to evaluate each currency value in the holdout set of currency values to determine 808 a next value currency score corresponding to the holdout set of currency values and a prediction score for each of the predicted currency values, where a prediction score can quantify the likelihood of a predicted currency value being the actual currency value for a period of time. The predicted currency value and prediction score can be compared to appropriate thresholds and a determination can be made 812 whether the scores satisfy respective thresholds. For example, the predicted currency value can be compared to a currency value threshold and the prediction score can be compared to prediction score threshold. In the situation where at least one of the predicted currency value or prediction score fails to satisfy a respective threshold, the process can repeat 813 for market data associated with a different time period. In the situation the predicted currency value and/or the prediction score satisfy respective thresholds, a financial transaction recommendation can be generated 814. In certain embodiments, at least one of the predicted currency value or the prediction score satisfies a respective threshold. As described herein, the thresholds to be satisfied, the amounts to satisfy the thresholds, etc., can be specified in an appropriate trade, purchase, or risk strategy provided by an appropriate entity. Thereafter, the predicted currency value can then be used to, for example, execute 816 the recommendation or be used for some other process.

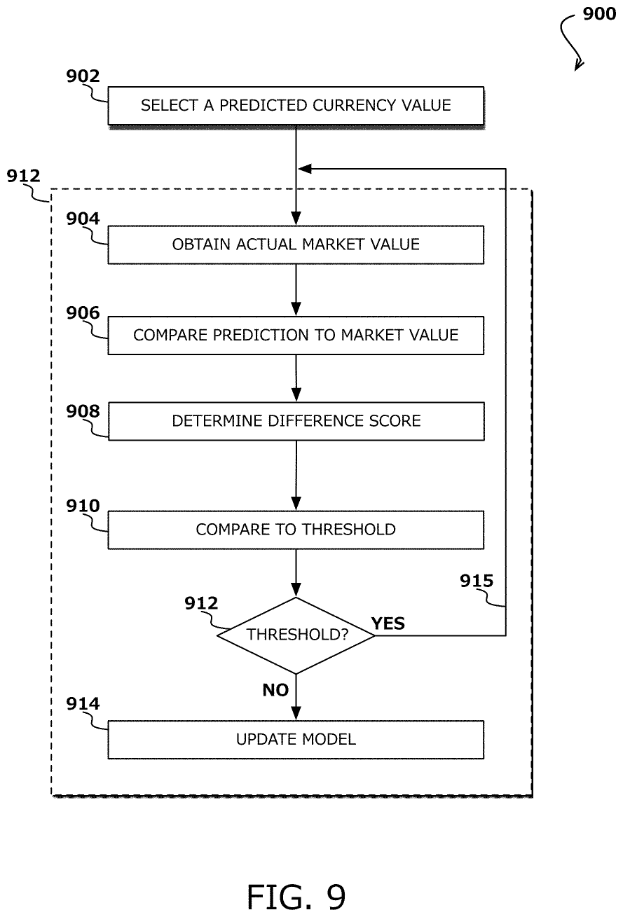

FIG. 9 illustrates an example process 900 for iteratively updating a prediction model that can be utilized in accordance with various embodiments. In this example, a predicted currency value is selected 902. A predicted currency value is a value of a currency for a future period of time. An actual currency value corresponding to the predicted currency value is obtained 904. For example, the predicted currency value corresponds to a value a future time. Once that future time is current, the actual currency value is known and can be obtained. The actual currency value is compared 906 to the predicted currency value to determine 908 a difference score. The difference score is compared 910 to a threshold (e.g., a difference threshold) and a determination is made 912 whether the difference score satisfies the threshold (e.g., difference threshold). In the situation the difference score fails to satisfy the threshold, the prediction model used to determine the predicted currency value is updated 914. In the situation the difference score satisfies the threshold, the process repeats 915, for example, when a new actual currency value for a subsequent period of time is determined. In various embodiments, one of a running error between actual currency value and predicted currency value, currencies associated with a highest value change, a running monetary gain for executing a financial transaction recommendation, or a running monetary loss for executing a financial transaction recommendation may be presented. For example, an interface including, for example, a graphical user interface (GUI), can be used to display the running error. In an example, the GUI may include different windows or panes, and each window, one or more windows, or a combination of windows can be used to present the running error, highest value change or currencies changing a determined threshold amount, the dynamic updating or running monetary gain or loss, among other such information.

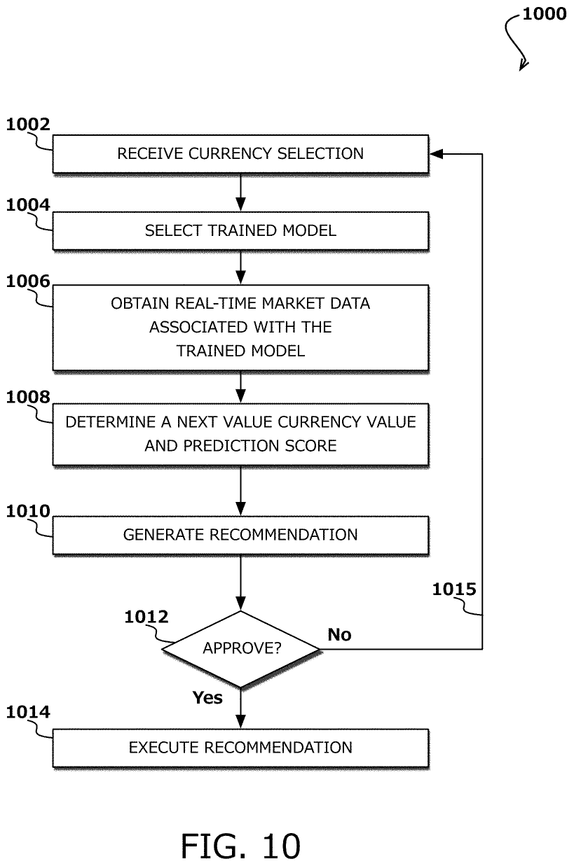

FIG. 10 illustrates an example process 1000 for executing recommendations based on a predicted currency value in accordance with various embodiments. In this example, a selection of a currency is received 1002. The selection can, for example, identify a currency for which a prediction is desired. For example, a user may indicate they want to know the currency value of the U.S. dollar for the next thirty minutes. Based on the selected currency, a trained model is selected 1004. For example, as described, models can be trained for particular currencies and can be used to predict a future currency value which can be used to determine time-limited exchange rates that can be used to determine, e.g., a next trade price or trade volume. In this instance, the selected currency can be associated with a model for that currency. Market data and market activity can be obtained 1006 for the appropriate model. In the situation the model has not been trained, the model can be trained for the indicated period of time. In the situation the model has been trained, the trained model can be used to determine 1008 a next value currency and a prediction score. A financial transaction recommendation can be generated 1010. The recommendations can be user generated (e.g., built using a recommendation generated) or other provided. In an example, the recommendations can include a list of assets to buy, hold, and/or sell, specific time intervals to execute trades or triggering events and/or times from these intervals, a particular volume to trade, a particular trade action to execute, etc. A determination is made 1012 whether to approve one or more recommendations. The determination can be based on an appropriate trade, purchase, or risk strategy provided by an appropriate entity. For example, the currency value and prediction score can be compared to respective thresholds. The range of allowable deviation from thresholds can be specified in one or more strategies. The strategies may also specify acceptable actions to take based on the deviation and/or whether a threshold is satisfied. In the situation where at least one of the predicted currency value or prediction score fails to satisfy a respective threshold, the process can repeat for market data associated with a different time period and/or currency selection. In the situation the predicted currency value and/or the prediction score satisfy respective thresholds for available recommendations, a financial transaction recommendation can be approved. In certain embodiments, a user can be provided the recommendations and can accept one or more of the recommendations, modify one or more recommendations, etc. In the situation at least one recommendation is manually approved or approved in accordance with an appropriate strategy, the recommendation can be executed 1014. For example, executed a recommendation may include buying, holding, and/or selling assets, initiating trades in accordance with the next currency and the period of time for which the next currency is valid, initiating a particular volume to trace, etc. In the situation a recommendation is not approved, the process can wait 1015 for the next currency selection.

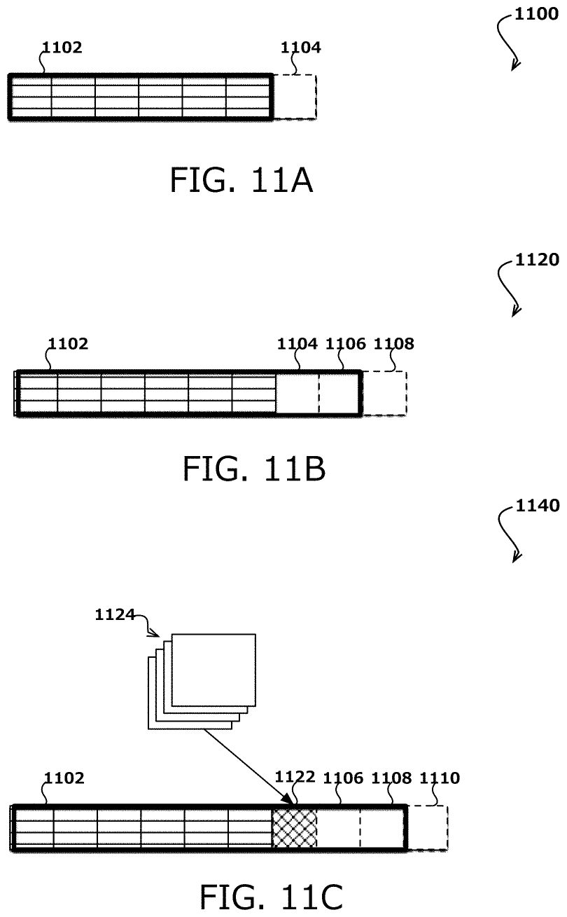

FIGS. 11A, 11B, and 11C illustrate an example of iteratively updating a prediction model in accordance with various embodiments. As illustrated in example 1100 of FIG. 11A, a prediction models is trained on market data 1102 to predict currency value 1104. Market data 1102 can correspond to a set of currency values of a particular type or category obtained for a specified period of time. As described, a prediction model can be trained for one or more currencies for different periods of time. In an example, training can be accomplished using any number of frequency or time domain scenarios. For instance, a model may forecast/predict the next X time interval of market data (e.g., currency values) by analyzing the input of the previous Y time interval of data.

Once predicted currency value 1104 is determined, market data 1102 is updated to include predicted currency value 1104. The prediction model is then used to evaluate market data 1102, now including predicted currency value 1104, to determine a second predicted currency value 1108, as illustrated in example 1120 of FIG. 11B. The process can continue until the predicted currency value for the desired future time is determined. As time progresses, an actual currency value for a predicted currency value may be obtained. For example, example 1140 of FIG. 11C illustrates actual currency value 1124 corresponding to predicted currency value 1104 being determined. In this example, predicted currency value 1104 can be compared to actual currency value 1124 to determine a difference score. The difference score is compared to a threshold and a determination is made whether the difference score satisfies the threshold. In the situation the difference score fails to satisfy the threshold, the prediction model used to determine predicted currency value 1104 is updated. In various embodiments, the predicted currency values determined after predicted currency value 1104 can also be updated. In the situation the difference score satisfies the threshold, and the predicted currency value for the desired future time has not been determined, predicted currency value 1110 and any remaining currency values can be determined. Thereafter, the predicted currency value can be used to determined, for example, time-limited exchange rates that can be used for a purchase transaction, document agreements, trade strategies, business trading or transaction insides, etc.

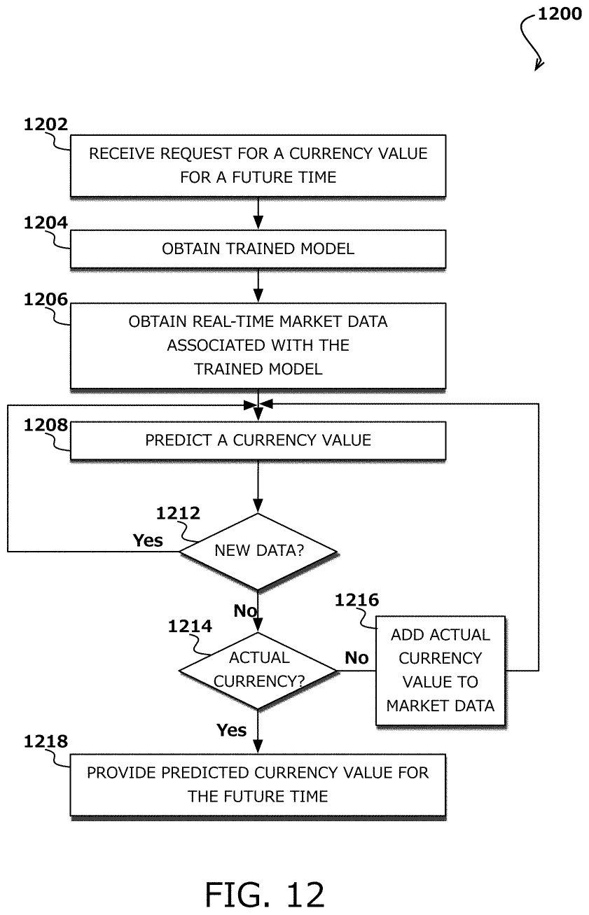

FIG. 12 illustrates an example process 1200 for updating prediction values in accordance with various embodiments. In this example, a request for a predicted currency value for a future time is received 1202. The currency can indicate a type of currency. Based on the type of currency, a trained model is obtained 1204. For example, as described, models can be trained for particular currencies and can be used to predict a future currency value which can be used to determine time-limited exchange rates that can be used to determine, e.g., a next trade price or trade volume. In this instance, the selected currency can be associated with a model for that currency. Market data and market activity for the period of time including the future currency value can be obtained 1206. In trained model can evaluate the real-time market data to predict 1208 a currency value for the future time. As new market data and market activity is obtained, a determination is made 1212 whether to update the predicted currency value. For example, particular market data and/or activity can be compared to one or more thresholds. In an example, this might include comparing financial indices, stock values, currency values, etc., to a corresponding threshold. In the situation the threshold is not satisfied, the predicted currency value can be updated using the new market data and market activity. In the situation the threshold is satisfied, a determination is made 1214 whether an actual currency value for a predicted currency value is available. In the situation an actual currency value corresponding to a predicted currency value is available, the predicted currency value can be compared to actual currency value to determine a difference score. The difference score can be compared to a threshold and a determination is made whether the difference score satisfies the threshold. In the situation the difference score fails to satisfy the threshold, the actual currency value is added 1216 to the market data and the prediction model used to determine predicted currency value is updated. Additionally, the predicted currency values determined after predicted currency value can be updated. In the situation the difference score satisfies the threshold, and the predicted currency value for the desired future time has not been determined, the predicted currency value and any remaining currency values can be determined and provided 1218 to an appropriate entity. Thereafter, the predicted currency value can be used to determined, for example, time-limited exchange rates that can be used for a purchase transaction, document agreements, trade strategies, business trading or transaction insides, etc.

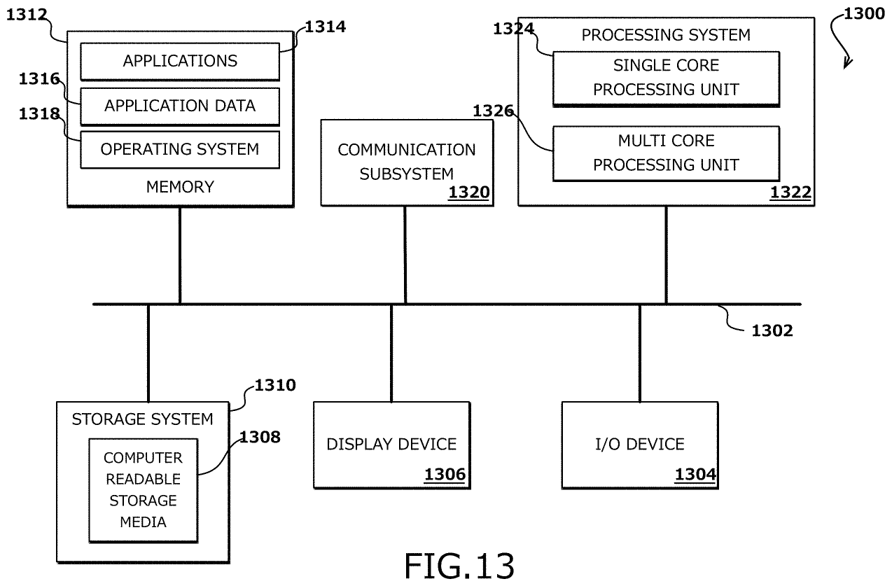

FIG. 13 illustrates a set of basic components of an electronic computing device 1300. In various embodiments, computer device 1300 may be used to implement any of the systems, devices, or methods described herein. In some embodiments, computer device 1300 may correspond to any of the various devices described herein, including, but not limited, to mobile devices, tablet computing devices, wearable devices, personal or laptop computers, vehicle-based computing devices, or other devices or systems described herein. As shown in FIG. 13, computer device 1300 can include various subsystems connected by a bus 1302. The subsystems may include an I/O device subsystem 1304, a display device subsystem 1306, and a storage subsystem 1310 including one or more computer-readable storage media 1308. The subsystems may also include a memory subsystem 1312, a communication subsystem 1320, and a processing subsystem 1322.

In device 1300, bus 1302 facilitates communication between the various subsystems. Although a single bus 1302 is shown, alternative bus configurations may also be used. Bus 1302 may include any bus or other components to facilitate such communication as is known to one of ordinary skill in the art. Examples of such bus systems may include a local bus, parallel bus, serial bus, bus network, and/or multiple bus systems coordinated by a bus controller. Bus 1302 may include one or more buses implementing various standards such as Parallel ATA, serial ATA, Industry Standard Architecture (ISA) bus, Extended ISA (EISA) bus, MicroChannel Architecture (MCA) bus, Peripheral Component Interconnect (PCI) bus, or any other architecture or standard as is known in the art.

In some embodiments, I/O device subsystem 1304 may include various input and/or output devices or interfaces for communicating with such devices. Such devices may include, without limitation, a touch screen or other touch-sensitive input device, a keyboard, a mouse, a trackball, a motion sensor or other movement-based gesture recognition device, a scroll wheel, a click wheel, a dial, a button, a switch, audio recognition devices configured to receive voice commands, microphones, image capture based devices such as eye activity monitors configured to recognize commands based on eye movement or blinking, and other types of input devices. I/O device subsystem 1304 may also include identification or authentication devices, such as fingerprint scanners, voiceprint scanners, iris scanners, or other biometric sensors or detectors. In various embodiments, I/O device subsystem may include audio output devices, such as speakers, media players, or other output devices.

Computer device 1300 may include a display device subsystem 1306. Display device subsystem may include one or more lights, such as one or more light emitting diodes (LEDs), LED arrays, a liquid crystal display (LCD) or plasma display or other flat-screen display, a touch screen, a head-mounted display or other wearable display device, a projection device, a cathode ray tube (CRT), and any other display technology configured to visually convey information. In various embodiments, display device subsystem 1306 may include a controller and/or interface for controlling and/or communicating with an external display, such as any of the above-mentioned display technologies.

As shown in FIG. 13, device 1300 may include storage subsystem 1310 including various computer-readable storage media 1308, such as hard disk drives, solid-state drives (including RAM-based and/or flash-based SSDs), or other storage devices. In various embodiments, computer-readable storage media 1308 can be configured to store software, including programs, code, or other instructions, that is executable by a processor (i.e., a computing processor) to provide the functionality described herein. For example, the instructions, when executed, can enable a computing device to obtain a plurality of currency values, a currency value associated with a currency and a time for identifying the currency value; separate the plurality of currency values into a first set of currency values, a second set of currency values, and a holdout set of currency values, wherein the first set of currency values includes currency received before a time period, the second set of currency values includes currency received during the time period, and the holdout set of currency values includes currency received during the time period and disjoint from the second set of currency values; train a prediction model on the first set of currency values and the second set of currency values to compute (e.g., determine or predict) a next value currency score; evaluate the prediction model on each currency value in the holdout set of currency values to determine (e.g., compute or predict) a set of next value currency scores corresponding to the holdout set of currency values; determine (e.g., compute or predict) a predicted next value currency score for a future time based on the set of next value currency scores, the predicted next value currency score associated with a confidence score (also referred to as a prediction score); and generate a financial transaction recommendation based on the confidence score.

In some embodiments, storage system 1310 may include various data stores or repositories or interface with various data stores or repositories that store data used with embodiments described herein. Such data stores may include, databases, object storage systems and services, data lakes or other data warehouse services or systems, distributed data stores, cloud-based storage systems and services, file systems, and any other data storage system or service. In some embodiments, storage system 1310 can include a media reader, card reader, or other storage interfaces to communicate with one or more external and/or removable storage devices. In various embodiments, computer-readable storage media 1308 can include any appropriate storage medium or combination of storage media. For example, computer-readable storage media 1308 can include, but is not limited to, any one or more of random access memory (RAM), read-only memory (ROM), electronically erasable programmable ROM (EEPROM), flash memory or other memory technology, optical storage (e.g., CD-ROM, digital versatile disk (DVD), Blu-ray® disk or other optical storage device), magnetic storage (e.g., tape drives, cassettes, magnetic disk storage or other magnetic storage devices). In some embodiments, computer-readable storage media can include data signals or any other medium through which data can be transmitted and/or received.

Memory subsystem 1312 can include various types of memory, including RAM, ROM, flash memory, or other memory. Memory 1312 can include SRAM (static RAM) or DRAM (dynamic RAM). In some embodiments, memory 1312 can include a BIOS (basic input/output system) or other firmware configured to manage initialization of various components during, e.g., startup. As shown in FIG. 13, memory 1312 can include applications 1314 and application data 1316. Applications 1314 may include programs, code, or other instructions, that can be executed by a processor. Applications 1314 can include various applications such as browser clients, campaign management applications, data management applications, and any other application. Application data 1316 can include any data produced and/or consumed by applications 1314. Memory 1312 can additionally include operating system 1318, such as macOS®, Windows®, Linux®, various UNIX® or UNIX- or Linux-based operating systems, or other operating systems.

Device 1300 can also include a communication subsystem 1320 configured to facilitate communication between device 1300 and various external computer systems and/or networks (such as the Internet, a local area network (LAN), a wide area network (WAN), a mobile network, or any other network). Communication subsystem 1320 can include hardware and/or software to enable communication over various wired (such as Ethernet or other wired communication technology) or wireless communication channels, such as radio transceivers to facilitate communication over wireless networks, mobile or cellular voice and/or data networks, WiFi networks, or other wireless communication networks. Additionally, or alternatively, communication subsystem 1320 can include hardware and/or software components to communicate with satellite-based or ground-based location services, such as GPS (global positioning system). In some embodiments, communication subsystem 1320 may include, or interface with, various hardware or software sensors. The sensors may be configured to provide continuous or and/or periodic data or data streams to a computer system through communication subsystem 1320

As shown in FIG. 13, processing system 1322 can include one or more processors or other devices operable to control computing device 1300. Such processors can include single-core processors 1324, multi-core processors, which can include central processing units (CPUs), graphical processing units (GPUs), application specific integrated circuits (ASICs), digital signal processors (DSPs) or any other generalized or specialized microprocessor or integrated circuit. Various processors within processing system 1322, such as processors 1324 and 1326, may be used independently or in combination depending on the application.

Various other configurations are may also be used, with particular elements that are depicted as being implemented in hardware may instead be implemented in software, firmware, or a combination thereof. One of ordinary skill in the art will recognize various alternatives to the specific embodiments described herein.

Various other configurations are may also be used, with particular elements that are depicted as being implemented in hardware may instead be implemented in software, firmware, or a combination thereof. One of ordinary skill in the art will recognize various alternatives to the specific embodiments described herein.

The various embodiments can be implemented in a wide variety of operating environments, which in some cases can include one or more user computers or computing devices which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, FTP, UPnP, NFS, and CIFS. The network can be, for example, a local area network, a wide-area network, a virtual private network, the internet, an intranet, an extranet, a public switched telephone network, an infrared network, a wireless network and any combination thereof.

In embodiments utilizing a web server, the web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random-access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or web browser. It should be appreciated that alternate embodiments may have numerous variations from that described above. For example, customized hardware might also be used, and/or particular elements might be implemented in hardware, software (including portable software, such as applets) or both. Further, connection to other computing devices such as network input/output devices may be employed.

Storage media and other non-transitory computer-readable media for containing code, or portions of code, can include any appropriate media known or used in the art, including storage media and communication media, such as but not limited to volatile and non-volatile, removable and non-removable media implemented in any method or technology for storage of information such as computer-readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

The methods, systems, and devices discussed above are described with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the above description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Having been provided with the description and illustration of the present application, one skilled in the art may envision variations, modifications, and alternate embodiments falling within the general inventive concept discussed in this application that do not depart from the scope of the following claims.

1: A computing system, comprising:
at least one computing processor; and
memory including instructions that, when executed by the at least one computing processor, enable the computing system to:
obtain currency data corresponding to a plurality of currency values associated with a plurality of financial entities in communication over a network in real-time, each currency value associated with a currency type and a timestamp, the timestamp indicating when the associated currency value was set;
determine a first set of currency values, a second set of currency values, and a holdout set of currency values by separating the plurality of currency values based on timestamps associated with the plurality of currency values and data training logic, wherein each of the first set of currency values is associated with its respective timestamp occurring before a time period, each of the second set of currency values is associated with its respective timestamp occurring during the time period, and each of the holdout set of currency values is associated with its respective timestamp occurring during the time period and disjoint from the second set of currency values;
train a machine learning prediction model on the first set of currency values and the second set of currency values, the machine learning prediction model operable to evaluate currency values to compute a next value currency score, the machine learning prediction model comprising a classification model constructed according to one or more of the data training logic, a neural network, and a logistic regression model;
evaluate the machine learning prediction model on each currency value in the holdout set of currency values to determine a set of potential next value currency values corresponding to the holdout set of currency values;
determine a next value currency value for a future time at least in part using one of thresholding or averaging of the set of potential next value currency values, the next value currency value associated with a confidence score; and
generate computer readable code corresponding to a user interface comprising a financial transaction recommendation based on the next value currency value and associated confidence score.

2: The computing system of claim 1, wherein the instructions when executed by the at least one computing processor further enable the computing system to:
generate a time-limited exchange rate between a first currency and a second currency for a purchase transaction based on the next value currency value.

3: The computing system of claim 1, wherein the next value currency value corresponds to a first predicted currency value for a first future time, and wherein the instructions when executed by the at least one computing processor further enable the computing system to:
evaluate the machine learning prediction model on a least a portion of the holdout set of currency values and the first predicted currency value to determine a second predicted currency value for a second future time.

4: The computing system of claim 1, wherein the instructions when executed by the at least one computing processor further enable the computing system to:
obtain an actual currency value for the next value currency value;
compare the actual currency value to the next value currency value to determine a difference;
determine whether or not the difference satisfies a difference threshold; and
if the difference satisfies the difference threshold, update the machine learning prediction model.

5: The computing system of claim 1, wherein the instructions when executed by the at least one computing processor further enable the computing system to:
obtain a trading strategy associated with a user account;
compare the confidence score to a threshold confidence score associated with a financial transaction recommendation identified in the trading strategy;
determine the confidence score satisfies the threshold confidence score; and
execute the trading strategy.

6: The computing system of claim 1, wherein the currency is one of a domestic currency, a foreign currency, a digital currency, or a cryptocurrency.

7: The computing system of claim 1, wherein the machine learning prediction model is one of stacked long short-term memory (LSTM) network, a logistic regression, Naive Baye, random forest, neural network, or support vector machines (SVMs).

8: The computing system of claim 1, wherein the financial transaction recommendation includes at least one of a specific time to trade a financial security, a trade volume for the financial security, a first set of financial securities to buy, a second set of financial securities to sell, or a third set of financial securities to hold.

9: The computing system of claim 1, wherein the instructions when executed by the at least one computing processor further enable the computing system to:
present one of a running error between actual currency value and predicted currency value, currencies associated with a highest value change, a running monetary gain for executing a financial transaction recommendation, or a running monetary loss for executing a financial transaction recommendation.

10: A computer-implemented method, comprising:
obtaining currency data corresponding to a plurality of currency values associated with a plurality of financial entities in communication over a network in real-time, each currency value associated with a currency type and a timestamp, the timestamp indicating when the associated currency value was set;
determining a first set of currency values, a second set of currency values, and a holdout set of currency values by separating the plurality of currency values based on timestamps associated with the plurality of currency values and data training logic, wherein each of the first set of currency values is associated with its respective timestamp occurring before a time period, each of the second set of currency values is associated with its respective timestamp occurring during the time period, and each of the holdout set of currency values is associated with its respective timestamp occurring during the time period and disjoint from the second set of currency values;
training a machine learning prediction model on the first set of currency values and the second set of currency values, the machine learning prediction model operable to evaluate currency values to compute a next value currency score, the machine learning prediction model comprising a classification model constructed according to one or more of the data training logic, a neural network, and a logistic regression model;
evaluating the machine learning prediction model on each currency value in the holdout set of currency values to determine a set of potential next value currency values corresponding to the holdout set of currency values;
determining a next value currency value for a future time at least in part using one of thresholding or averaging of the set of potential next value currency values, the next value currency value associated with a confidence score; and
generating computer readable code corresponding to a user interface comprising a financial transaction recommendation based on the next value currency value and associated confidence score.

11: The computer-implemented method of claim 10, further comprising:
generating a time-limited exchange rate between a first currency and a second currency for a purchase transaction based on the next value currency value.

12: The computer-implemented method of claim 10, wherein the next value currency value corresponds to a first predicted currency value for a first future time, the computer-implemented method further comprising:
evaluating the machine learning prediction model on a least a portion of the holdout set of currency values and the first predicted currency value to determine a second predicted currency value for a second future time.

13: The computer-implemented method of claim 10, further comprising:
obtaining an actual currency value for the next value currency value;
comparing the actual currency value to the next value currency value to determine a difference;
determining whether or not the difference satisfies a difference threshold; and
if the difference satisfies the difference threshold, updating the machine learning prediction model.

14: The computer-implemented method of claim 10, further comprising:
obtaining a trading strategy associated with a user account;
comparing the confidence score to a threshold confidence score associated with a financial transaction recommendation identified in the trading strategy;
determining the confidence score satisfies the threshold confidence score; and executing the trading strategy.

15: The computer-implemented method of claim 10, wherein the financial transaction recommendation includes at least one of a specific time to trade a financial security, a trade volume for the financial security, a first set of financial securities to buy, a second set of financial securities to sell, or a third set of financial securities to hold.

16: The computer-implemented method of claim 10, further comprising:
presenting one of a running difference between actual currency value and predicted currency value, currencies associated with a highest value change, a running monetary gain for executing a financial transaction recommendation, or a running monetary loss for executing a financial transaction recommendation.

17: A non-transitory computer readable storage medium storing instructions that, when executed by at least one processor of a computing system, causes the computing system to:
obtain currency data corresponding to a plurality of currency values associated with a plurality of financial entities in communication over a network in real-time, each currency value associated with a currency type and a timestamp, the timestamp indicating when the associated currency value was set;
determine a first set of currency values, a second set of currency values, and a holdout set of currency values by separating the plurality of currency values based on timestamps associated with the plurality of currency values and data training logic, wherein each of the first set of currency values is associated with its respective timestamp occurring before a time period, each of the second set of currency values is associated with its respective timestamp occurring during the time period, and each of the holdout set of currency values is associated with its respective timestamp occurring during the time period and disjoint from the second set of currency values;
train a machine learning prediction model on the first set of currency values and the second set of currency values, the machine learning prediction model operable to evaluate currency values to compute a next value currency score, the machine learning prediction model comprising a classification model constructed according to one or more of the data training logic, a neural network, and a logistic regression model;
evaluate the machine learning prediction model on each currency value in the holdout set of currency values to determine a set of potential next value currency values corresponding to the holdout set of currency values;
determine a next value currency value for a future time at least in part using one of thresholding or averaging of the set of potential next value currency values, the next value currency value associated with a confidence score; and
generate computer readable code corresponding to a user interface comprising a financial transaction recommendation based on the next value currency value and associated confidence score.

18: The non-transitory computer readable storage medium of claim 17, wherein the instructions, when executed by the at least one processor, further enables the computing system to:
generate a time-limited exchange rate between a first currency and a second currency for a purchase transaction based on the next value currency value.

19: The non-transitory computer readable storage medium of claim 17, wherein the next value currency value corresponds to a first predicted currency value for a first future time, and wherein the instructions, when executed by the at least one processor, further enables the computing system to:
evaluate the machine learning prediction model on a least a portion of the holdout set of currency values and the first predicted currency value to determine a second predicted currency value for a second future time.

20: The non-transitory computer readable storage medium of claim 17, wherein the instructions, when executed by the at least one processor, further enables the computing system to:
obtain an actual currency value for the next value currency value;
compare the actual currency value to the next value currency value to determine a difference;
determine whether or not the difference satisfies a difference threshold; and
if the difference satisfies the difference threshold, update the machine learning prediction model.
